(19) United States
(12) Patent Application Publication
(10) Pub. No.: US 2019/0138950 A1
(43) Pub. Date: May 9, 2019

(54) DYNAMIC TRAVEL INSTALLMENT SYSTEM IN AN ONLINE MARKETPLACE

(71) Applicant: Airbnb, Inc., San Francisco, CA (US)

(72) Inventors: Lex Neal Bayer, Menlo, CA (US); Jonathan Paul Golden, San Francisco, CA (US); Mai Leduc, San Francisco, CA (US); Kapil Mokhat, San Ramon, CA (US)

(21) Appl. No.: 15/805,853

(22) Filed: Nov. 7, 2017

(51) Int. Cl. G06Q 10/02; G06Q 20/22

(52) U.S. Cl. CPC G06Q 10/02; G06Q 20/22

(57) ABSTRACT

Systems and methods are provided for analyzing a cancellation policy for a trip item to determine payment parameters set for the trip item, and for each of a plurality of predetermined number of installment payments, calculating a payment period for each payment parameter set for the trip item based on a time period before payment is due to meet each payment parameter and the predetermined number of installments. The systems and methods further provide for selecting a number of predetermined installment payments of the plurality of predetermined number of installment payments that comprises an optimal payment period between a final installment payment and the start date of the trip item, generating an installment plan based on the selected number of predetermined installment payments, the installment plan comprising a date and amount for each installment payment, and causing the installment plan to be presented via the computing device.

### BACKGROUND

Paying for a vacation or travel expenses can be expensive. Often people save up for months to be able to afford the vacation of their choice, and paying a large sum up front can be onerous for many people.

A travel platform, such as in an online marketplace for travel, that allows users to pay over time and pay less up front can make it easier for many people to be able to afford a trip. The challenge for the travel platform is that allowing users to pay for the trip in installments (e.g., multiple payments) typically requires the travel platform to assume credit risk if the user does not complete all the payments. In this case, the travel platform would still pay out the hosts (e.g., property owners, experience providers, etc.) who took the booking, even though the platform did not collect all of the payments. Assuming credit risk can lead to losses, or complex relationships with third parties to manage credit score screenings or adjust terms based on the credit profile of the user.

This is further complicated by travel platforms that have a large offering of inventory. As an example, an online marketplace may have millions of listings for various trip items and millions of hosts managing the trip items. For example, the online marketplace may have millions of accommodations from many different sources with many different terms and payment guarantees, or different types of trip items (such as accommodations, experiences, services and flights) that have varying terms and payment needs. In one example, a vacation rental property might require being paid 60 days in advance, whereas a tour operator might require being paid 30 days after the tour.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some example embodiments.

FIG. 2 is a block diagram illustrating a reservation system, according to some example embodiments.

FIG. 3 is a flow chart illustrating aspects of a method for generating an installment plan for a trip item, according to some example embodiments.

FIG. 4 is an example user interface for viewing details of a listing for a trip item, according to some example embodiments.

FIG. 5 is a block diagram illustrating an example of a software architecture that may be installed on a machine, according to some example embodiments.

FIG. 6 illustrates a diagrammatic representation of a machine, in the form of a computer system, within which a set of instructions may be executed for causing the machine to perform any one or more of the methodologies discussed herein, according to an example embodiment.

### DETAILED DESCRIPTION

Systems and methods described herein relate to a dynamic travel installment system for an online marketplace. As explained above, an online marketplace may have millions of listings for various trip items and millions of hosts managing the trip items. Example embodiments provide an online marketplace that can dynamically generate an installment plan that accounts for specific parameters set by a trip item manager for each individual trip item and allows for installment payments for users (e.g., travelers, guests, etc.) while at the same time not creating credit risk for the online marketplace that is offering installment payment options.

In an online market place, each manager for a trip item may set parameters for payment and a cancellation policy independently, and the online marketplace may set user or guest policies for each trip item independently. This means that a policy set by a manager for a trip item and a guest policy may be (or will likely be) different. Scale this to millions of listings for trip items, millions of managers of trip items, and millions of guests, and the problem becomes quite unwieldy. Example embodiments can analyze a trip item policy and a guest policy to match the two with an installment plan that uniquely solves for the disparate needs of a host and a guest. Example embodiments may do this with hundreds of thousands of varieties, and without requiring a guest and a host to communicate and make any adjustments to their needs or policies. Propagate this over a massive platform with millions of users and matching payments to cancellation polices is not something that can be solved at the individual level in the offline world.

Typical solutions that allow for installment payments for travel platforms manage the credit risk in a few different ways. A first example is to pass the risk on to the provider or host. In this example, if the guest does not pay the full amount, the provider or host is left with a loss, or would need to continue to try and collect the full amount from the guest outside of the platform. A second example is to pass the risk on to a third party (such as a bank) who will determine how much risk it is comfortable taking on and when and if it will allow a particular user to pay via installments based on their credit profile. Another example is where the platform assumes the risk, which typically means absorbing a certain amount of losses when users do not pay the full amount.

Example embodiments provide a dynamic travel installment system and methods that adjust the installment plan offered to users based on the cancellation policy of the particular trip item so as to remove credit risk to the platform. For example, the dynamic travel installment system adjusts the time period for re-payment and amounts to take into account the cancellation policy associated with the particular trip item.

As an example, a first trip item may be a property A and a second trip item may be a property B. Property A and property B have two different cancellations policies, A and B. Policy A, for property A, is a strict policy, which means that if the user cancels within 30 days of the reservation, they owe the host 100% of the booking amount. Policy B, for property B, is a flexible policy, which means that if the user cancels within 30 days of the reservation, they owe the host 50% of the booking amount, and if the users cancels within 7 days, they owe 100%. The installment plans offered by the online marketplace to a user looking at Policy A and Policy B will adjust the payment offering to maintain no credit risk to the online marketplace if the full amounts are not collected at any point in time.

In another example, a user may want to book property A for a trip in six months. The online marketplace may calculate and offer the user an installment plan of, say, 50% at the time of booking, and 50% at 31 days before the trip starts. In this situation, so long as the user pays 100% of the reservation by 31 days prior to the trip, the reservation will stand. However, if the user pay 50% up front, and fails to pay the remainder on the second installment date of 31 days prior to the trip, then the online marketplace will cancel the reservation. By cancelling the reservation ahead of the window where the cancellation policy would require a payment to the host, no credit risk is assumed by the online marketplace. The host receives 50% of the booking amount for the initial booking, which the platform has already collected, and the other 50% is not due because the reservation was cancelled prior to the date when the next 50% would be at risk.

If the user wants to book property B for a trip in six months, then the online marketplace may calculate and offer an installment plan that allows the user to pay 50% up front, and the remaining 50% at 8 days before the reservation starts. If the user cancels, for example, 30 days before the reservation, the 50% that would be owed to the host has already been collected and so the platform has not assumed any credit risk. If the traveler fails to pay by 8 days prior to the reservation, then the reservation will be cancelled so that the platform does not take on any credit risk.

In another example, if a user wants to book property A in four months and pay over four installments rather than two, then the platform may calculate and offer an installment plan that requires ¼ of the full amount at booking, ¼ at 91 days prior, ¼ at 61 days prior and ¼ at 31 days prior. Whereas if the same user looks at property B, the last installment of ¼ of the payment would only need to be collected 8 days before the reservation, resulting in a different payment installment option presented to the traveler of ¼ at booking, ¼ at 83 days prior, at 45 days prior, and a ¼ at 8 days prior.

To generalize the use case, the installment plan calculated and offered by the platform may adjust as follows. At any point in time p, the consequence of a reservation being cancelled will result in a host payment of q. The installment plan offered to a user adjusts such that at any time p+1 day, q has already been collected by the user so that no credit risk is taken by the platform. As the time to a reservation gets closer and the cancellation policies windows go into effect, additional installments are collected such that in no situation can a cancellation happen where the host would be owed more than the amount that has been collected by the user.

Numerous variables may be adjusted through this method, including the dates of collection of payment, the amount collected at each period, and the frequency or number of collections. To simplify the user experience, the online marketplace can adjust the offer to create payment schedules and amounts that are intuitive for the traveler to understand, such as monthly repayment schedules, or round number amounts to be collected at various dates. Moreover, different users may get different options for an installment plan based on the particular trip item and based on the user's policy and/or needs.

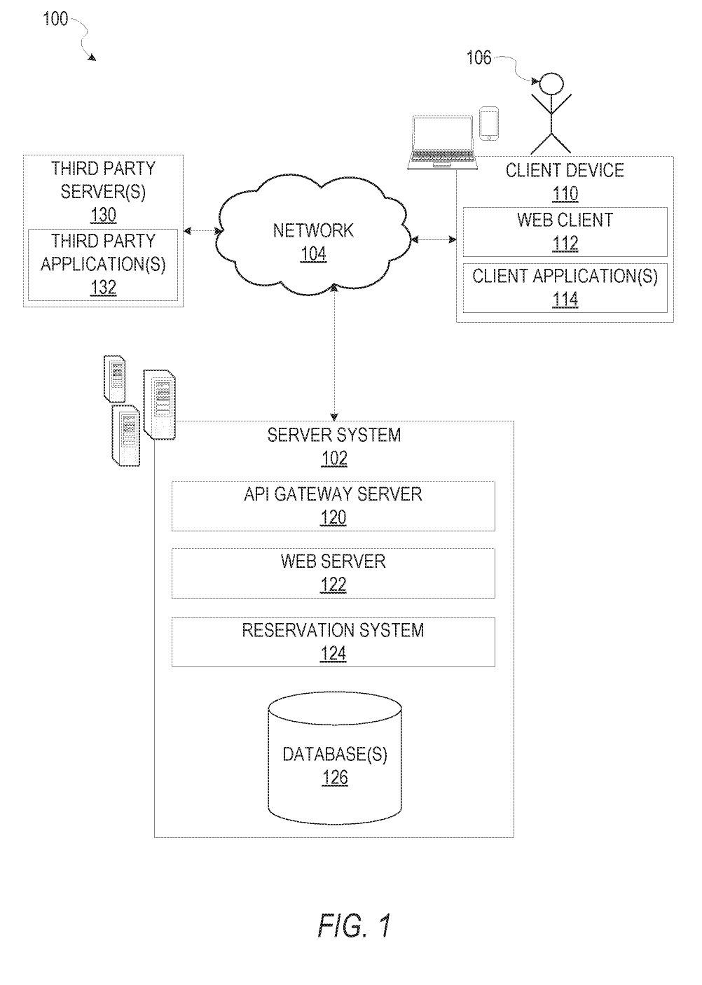

FIG. 1 is a block diagram illustrating a networked system 100, according to some example embodiments. The system 100 may include one or more client devices such as client device 110. The client device 110 may comprise, but is not limited to, a mobile phone, desktop computer, laptop, portable digital assistant (PDA), smart phone, tablet, ultrabook, netbook, laptop, multi-processor system, microprocessor-based or programmable consumer electronic, game console, set-top box, computer in a vehicle, or any other communication device that a user may utilize to access the networked system 100. In some embodiments, the client device 110 may comprise a display module (not shown) to display information (e.g., in the form of user interfaces). In further embodiments, the client device 110 may comprise one or more of touch screens, accelerometers, gyroscopes, cameras, microphones, global positioning system (GPS) devices, and so forth. The client device 110 may be a device of a user that is used to request and receive reservation information, accommodation information, and so forth, associated with individual or group travel.

One or more users 106 may be a person, a machine, or other means of interacting with the client device 110. In example embodiments, the user 106 may not be part of the system 100, but may interact with the system 100 via the client device 110 or other means. For instance, the user 106 may provide input (e.g., voice, touch screen input, alphanumeric input, etc.) to the client device 110 and the input may be communicated to other entities in the system 100 (e.g., third party servers 130, server system 102, etc.) via a network 104. In this instance, the other entities in the system 100, in response to receiving the input from the user 106, may communicate information to the client device 110 via the network 104 to be presented to the user 106. In this way, the user 106 may interact with the various entities in the system 100 using the client device 110.

The system 100 may further include a network 104. One or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a WiMax network, another type of network, or a combination of two or more such networks.

The client device 110 may access the various data and applications provided by other entities in the system 100 via web client 112 (e.g., a browser, such as the Internet Explorer® browser developed by Microsoft® Corporation of Redmond, Wash. State) or one or more client applications 114. The client device 110 may include one or more client applications 114 (also referred to as “apps”) such as, but not limited to, a web browser, messaging application, electronic mail (email) application, an e-commerce site application, a mapping or location application, a reservation application, and the like.

In some embodiments, one or more client applications 114 may be included in a given one of the client device 110 and configured to locally provide the user interface and at least some of the functionalities, with the client application 114 configured to communicate with other entities in the system 100 (e.g., third party servers 130, server system 102, etc.), on an as-needed basis, for data and/or processing capabilities not locally available (e.g., access reservation information or listing information, to request data, to authenticate a user 106, to verify a method of payment, etc.). Conversely, one or more applications 114 may not be included in the client device 110, and then the client device 110 may use its web browser to access the one or more applications hosted on other entities in the system 100 (e.g., third party servers 130, server system 102, etc.).

The system 100 may further include one or more third party servers 130. The one or more third party servers 130 may include one or more third party application(s) 132. The one or more third party application(s) 132, executing on third party server(s) 130, may interact with the server system 102 via API gateway server 120 via a programmatic interface provided by the API gateway server 120. For example, one or more of the third party applications 132 may request and utilize information from the server system 102 via the API gateway server 120 to support one or more features or functions on a website hosted by the third party or an application hosted by the third party. The third party website or application 132, for example, may provide various functionality that is supported by relevant functionality and data in the server system 102.

A server system 102 may provide server-side functionality via the network 104 (e.g., the Internet or wide area network (WAN)) to one or more third party servers 130 and/or one or more client devices 110. The server system 102 may be a cloud computing environment, according to some example embodiments. The server system 102, and any servers associated with the server system 102, may be associated with a cloud-based application, in one example embodiment.

In one example, the server system 102 provides server-side functionality for an online marketplace. The online marketplace may provide various listings for trip items, such as for accommodations hosted by various managers, which can be reserved by clients, such as for an apartment, a house, a cabin, one or more rooms in an apartment or house, and the like. For example, one manager or owner of a home may list one or more rooms in his own home on the online marketplace, a second manager of a home may list an entire home on the online marketplace, a third manager may list an entire cabin on the online marketplace, and so forth. Each manager may provide a different cancellation policy, payment parameters, guest policy, and so forth, for each listing for a trip item hosted by the manager.

In one example, the listings may be time-expiring inventory. With time-expiring inventory (e.g., time-expiring accommodations), if the inventory is not booked and used before it expires, the inventory is wasted and the manager receives no revenue. The online marketplace may further provide listings for other trip items, such as experiences (e.g., local tours), car rental, flights, public transportation, and other transportation or activities related to travel.

The server system 102 may include an application program interface (API) gateway server 120, a web server 122, and a reservation system 124, that may be communicatively coupled with one or more databases 126 or other form of data store.

The one or more databases 126 may be one or more storage devices that store data related to a reservation system 124, and other systems or data. The one or more databases 126 may further store information related to third party servers 130, third party applications 132, client devices 110, client applications 114, users 106, and so forth. The one or more databases 126 may be implemented using any suitable database management system such as MySQL, PostgreSQL, Microsoft SQL Server, Oracle, SAP, IBM DB2, or the like. The one or more databases 126 may include cloud-based storage, in some embodiments.

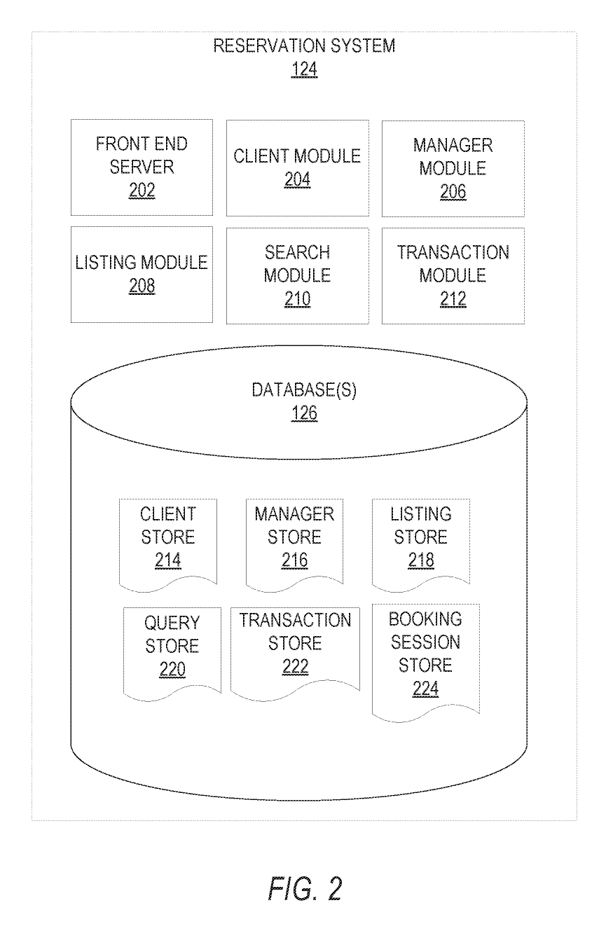

The reservation system 124 may manage resources and provide back-end support for third party servers 130, third party applications 132, client applications 114, and so forth, which may include cloud-based applications. The reservation system 124 may provide functionality for viewing listings related to trip items (e.g., accommodation listings, activity listings, etc.), managing listings, booking listings and other reservation functionality, and so forth, for an online marketplace. Further details related to the reservation system 124 are shown in FIG. 2.

FIG. 2 is a block diagram illustrating a reservation system 124, according to some example embodiments. The reservation system 124 comprises a front end server 202, a client module 204, a manager module 206, a listing module 208, a search module 210, and a transaction module 212. The one or more database(s) 126 include a client store 214, a manager store 216, a listing store 218, a query store 220, a transaction store 222, and a booking session store 224. The reservation system 124 may also contain different and/or other modules that are not described herein.

The reservation system 124 may be implemented using a single computing device or network of computing devices, including cloud-based computer implementations. The computing devices may be server class computers including one or more high-performance computer processors and random access memory, which may run an operating system such as LINUX or the like. The operations of the reservation system 124 may be controlled through either hardware or through computer programs installed in non-transitory computer-readable storage devices such as solid-state devices or magnetic storage devices and executed by the processors to perform the functions described herein.

The front end server 202 includes program code that allows client and manager client devices 110 to communicate with the reservation system 124. The front end server 202 may utilize the API gateway server 120 and/or the web server 122 shown in FIG. 1. The front end server 202 may include a web server hosting one or more websites accessible via a hypertext transfer protocol (HTTP), such that user agents, such as a web browser software application, may be installed on the client devices 110, and can send commands and receive data from the reservation system 124. The front and server 202 may also utilize the API gateway server 120 that allows software applications installed on client devices 110 to call to the API to send commands and receive data from the reservation system 124. The front end server 202 further includes program code to route commands and data to the other components of the reservation system 124 to carry out the processes described herein and respond to the client devices 110 accordingly.

The client module 204 comprises program code that allows clients (also referred to herein as “users” or “guests”) to manage their interactions with the reservation system 124, and executes processing logic for client-related information that may be requested by other components of the reservation system 124. Each client is represented in the reservation system 124 by an individual client object having a unique client ID and client profile (also referred to herein a “user profile”), both which are stored in the client store 214.

The client profile includes a number of client-related attribute fields that may include a profile picture and/or other identifying information, a geographical location, a client calendar, and so forth. The client's geographic location is either a client's current location (e.g., based on information provided by the client device 110), or their manually entered home address, neighborhood, city, state, or country of residence. The client location may be used to filter search criteria for time expiring inventory relevant to a particular client or assign default language preferences. The client attributes or features are further described below.

The client profile may further comprise a payment history for past trip items, whether or not the client has been verified, reviews for the client (e.g., reviews from other users (e.g., clients and managers) about the user), and so forth.

The client module 204 provides code for clients to set up and modify the client profile. The reservation system 124 allows each client to communicate with multiple managers. The reservation system 124 allows a client to exchange communications, request for transactions, and perform transactions with managers.

The manager module 206 comprises program code that provides a user interface that allows managers (also referred to herein as “hosts” or “owners”) to manage their interactions and listings with the reservation system 124 and executes processing logic for manager-related information that may be requested by other components of the reservation system 124. Each manager is represented in the reservation system 124 by an individual manager object having a unique manager ID and manager profile, both of which are stored in manager store 216.

The manager profile is associated with one or more listings owned or managed by the manager, and includes a number of manager attributes including transaction requests and a set of listing calendars for each of the listings managed by the manager. The client attributes or features are further described below.

The manager module 206 provides code for managers to set up and modify the manager profile listings. A user 106 of the reservation system 124 can be both a manager and a client. In this case, the user 106 will have a profile entry in both the client store 214 and the manager store 216 and be represented by both a client object and a manager object. The reservation system 124 allows the manager to exchange communications, respond to requests for transactions, and conduct transactions with other managers.

The listing module 208 comprises program code for managers to list trip items, such as time expiring inventory, for booking by clients. The listing module 208 is configured to receive the listing from a manager describing the inventory being offered, a timeframe of its availability including one or more of the start date, end dates, start time, and an end time, a price, a geographic location, images and description that characterize the inventory, and any other relevant information. For example, for an accommodation reservation system, a listing may include a type of accommodation (e.g., house, apartment, room, sleeping space, or other), a representation of its size (e.g., square footage, or number of rooms), the dates that the accommodation is available, and a price (e.g., per night, per week, per month, etc.). The listing module 208 allows a user 106 to include additional information about the inventory, such as videos, photographs and other media.

The geographical location associated with the listing identifies the complete address, neighborhood, city, and/or country of the offered listing. The listing module 208 is also capable of converting one type of location information (e.g., mailing address) into another type of location information (e.g., country, state, city, and neighborhood) using externally available geographical map information.

The price of the listing is the amount of money a client needs to pay in order to complete a transaction for the inventory. The price may be specified as an amount of money per day, per week, per month, and/or per season, or other interval of time specified by the manager. Additionally, price may include additional charges such as accommodation inventory, cleaning fees, pet fees, service fees, and taxes, or the listing price may be listed separately from additional charges. The listing attributes or features are further described below.

Each listing is represented in the reservation system 124 by a listing object which includes the listings information as provided by the manager and a unique listing ID, both of which are stored in the listing store 218. Each listing object is also associated with the manager object for the manager providing the listing.

Each listing object has an associated listing calendar. The listing calendar stores the availability of the listing for each time interval in a time period (each of which may be thought of as an independent item of time-expiring inventory), as specified by the manager or determined automatically (e.g., through a calendar import process). For example, a manager may access the listing calendar for a listing and manually indicate which time intervals that the listing is available for transaction by a client, which time intervals are blocked by the manager as being unavailable, and which time intervals are already in transaction (e.g., booked) for a client. In addition, the listing calendar continues to store historical information as to the availability of the listing identifying which past time intervals were booked by clients, blocked, or available. Further, the listing calendar may include calendar rules (e.g., the minimum and maximum number of nights allowed for the inventory, a minimum or maximum number of nights needed between bookings, minimum or maximum people allowed for the inventory, etc.). Information from each listing calendar is stored in the listing store 218.

The search module 210 comprises program code configured to receive an input search query from a client and return a set of time expiring inventory and/or listings that match the input query. Search queries are saved as query objects stored by the reservation system 124 in the query store 220. A query may contain a search location, a desired start time/date, a desired duration, a desired listing type, and a desired price range, and may also include other desired attributes or features of the listing. A potential client need not provide all the parameters of the query listed above in order to receive results from the search module 210. The search module 210 provides a set of time-expiring inventory and/or listings in response to the submitted query to fulfill the parameters of the submitted query. The online system may also allow clients to browse listings without submitting a search query, in which case the viewing data recorded will only indicate that a client has viewed the particular listing without any further details from the submitted search query. When the client provides input selecting a time expiring inventory/listing to more carefully review for a possible transaction to reserve the listing, the search module 210 records the selection/viewing data indicating which inventory/listing the client viewed. This information is also stored in the query store 220.

The transaction module 212 comprises program code configured to enable clients to submit a contractual transaction request (also referred to as formal requests) to transact for time expiring inventory. In operation, the transaction module 212 receives a transaction request from a client to transact for an item of time expiring inventory, such as a particular date range for a listing offered by a particular manager. A transaction request may be a standardized request form that is sent by the client, which may be modified by responses to the request by the manager, either accepting or denying a received request form, such that agreeable terms are reached between the manager and the client. Modifications to a received request may include, for example, changing the date, price, or time/date range (and thus, effectively, which time expiring inventories are being transacted for). The standardized forms may require the client to record the start time/date, duration (or end times), or any other details that must be included for an acceptance to be binding without further communication.

The transaction module 212 receives the filled out request form from the client and presents the completed request form including the booking parameters to the manager associated with the listing. The manager may accept the request, reject the request, or provide a proposed alternative that modifies one or more of the parameters. If the manager accepts the request (or the client accepts the proposed alternative), then the transaction module 212 updates an acceptance status associated with the request and the time-expiring inventory to indicate that the request was accepted. The client calendar and the listing calendar are also updated to reflect that the time-expiring inventory has been transacted for the particular time interval. Other models not specifically described herein allow the client to complete payment and for the manager to receive payment.

The transaction module 212 may further comprise code configured to generate an installment plan based on a cancellation policy set by a manager of a trip item to enable clients to pay via an installment plan. The transaction module 212 comprises code configured to generate a total amount payable by the client or an installment plan with dates and amounts that may be paid at particular time periods. Further details for generating an installment plan are described below.

The transaction store 222 stores requests made by clients. Each request is represented by a request object. The request includes a timestamp, a requested start time, and a requested duration or reservation end time. Because the acceptance of a booking by a manager is a contractually binding agreement with the client that the manager will provide the time-expiring inventory to the client at the specified times, all the information that the manager needs to approve such an agreement is included in the request. A manager response to a request is comprised of a value indicating acceptance or denial and a timestamp. Other models may allow for instant booking, as described below.

The transaction module 212 may also provide managers and clients with the ability to exchange informal requests to transact. Informal requests are not sufficient to be binding upon the client or manager if accepted, and in terms of content, may vary from mere communications and general inquiries regarding the availability of inventory, to requests that fall just short of whatever specific requirements the reservation system 124 sets forth for formal transaction requests. The transaction module 212 may also store informal requests in the transaction store 222, as both informal and formal requests provide useful information about the demand for time-expiring inventory.

The booking session store 224 stores booking session data for all booking sessions performed by clients. Booking session data may include details about a listing that was booked and data about one or more other listings that were viewed (or seriously considered) but not booked by the client before booking the listing. For example, once a listing is booked, the transaction module 212 may send data about the listing, the transaction, viewing data that was recorded for the booking session, and so forth, to be stored in the booking session store 224. The transaction module 212 may utilize other modules or data stores to generate booking session data to be stored in the booking session store 224.

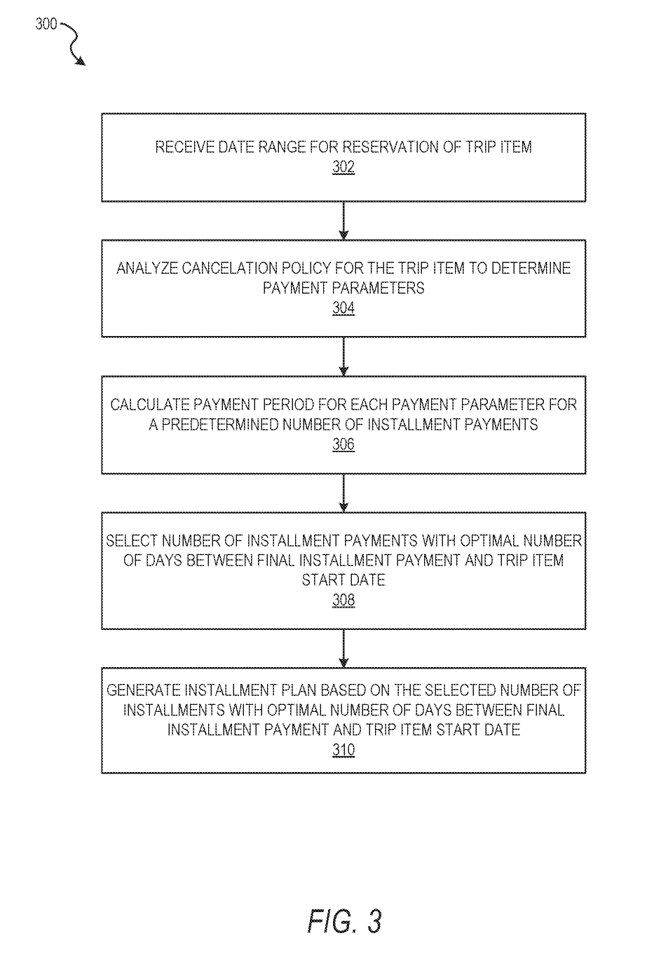

FIG. 3 is a flow chart illustrating aspects of a method 300, for generating an installment plan for a reservation for a trip item, according to some example embodiments. For illustrative purposes, method 300 is described with respect to the networked system 100 of FIG. 1 and FIG. 2. It is to be understood that method 300 may be practiced with other system configurations in other embodiments.

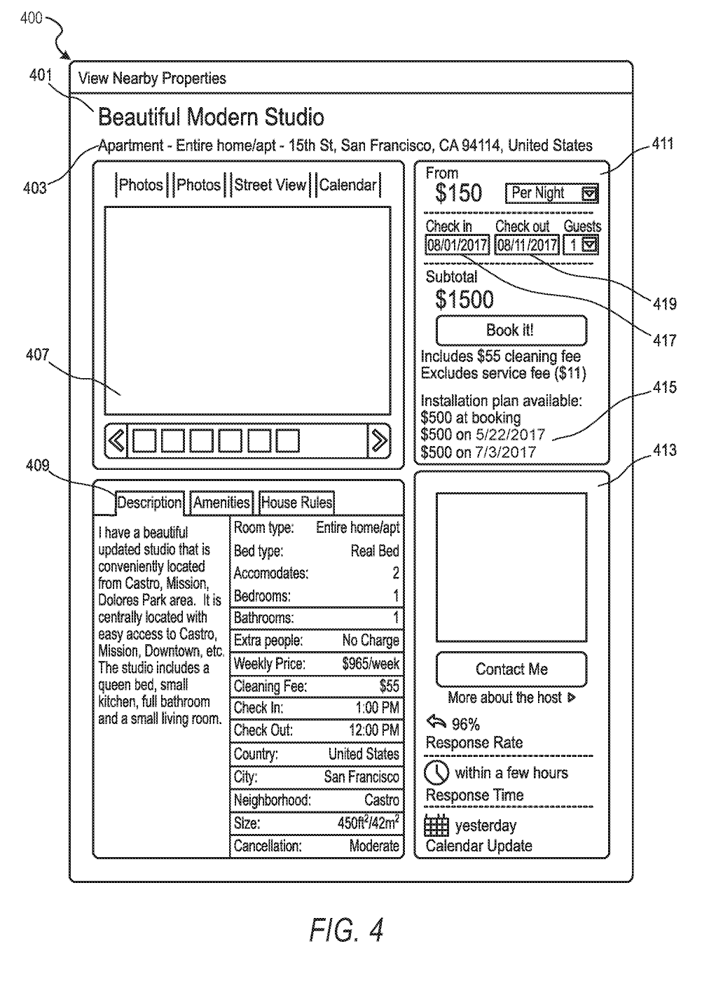

In operation 302, a server computing system (e.g., server system 102) receives (e.g., via reservation system 124) a date range for a reservation for a trip item. The date range may comprise a start date for the trip item and an end date for the trip item. For example, a user may be viewing a listing for a studio apartment in San Francisco. In one example, the user may view the listing in a user interface on a computing device (e.g., client device 110). FIG. 4 illustrates an example user interface 400 for a description of a listing for a trip item (e.g., an apartment in San Francisco) in an online marketplace. The example listing shown in FIG. 4 is for accommodations in San Francisco. In other examples, the listing could be for a tour, local experience, transportation, or other trip item. The listing may include a title 401 and a brief description 403 of the trip item. The listing may further include photos of the trip item, maps of the area or location associated with the trip item, a street view of the trip item, a calendar of the trip item, and so forth, which may be viewed in area 407. The listing may include a detailed description 409, pricing information 411, and the listing host's information 413. The listing may further include installment plan information 415.

In one example, the user may select a date range for the trip item by entering or choosing specific check-in date 417 and check-out date 419. For example, the user may indicate specific dates for which he would like to reserve the studio apartment (e.g., Aug. 1, 2017 to Aug. 10, 2017, or Jul. 23, 2017, etc.). The computing device may send the date or date range to the server computing system once they are entered by the user. Other information may be sent with the date or date range, such as a listing identifier, user identifier (e.g., client ID), and so forth. The server computing system may determine a start date for the trip item, a number of days for a reservation of the trip item, a total amount of payment for the reservation, and so forth, based on the date range and listing data associated with the trip item.

Returning to FIG. 3, in operation 304, the server computing system analyzes a cancellation policy to determine payment parameters for the trip item. In one example, the payment parameters may be set by a manager of the trip item or a system associated with the trip item, and be specific to the trip item. For example, the server computing system may access a listing store 218 to determine the details of the listing for the trip item, including the cancellation policy for the trip item. For example, the listing may have a cancellation policy that includes one or more payment parameters that should be met to avoid cancellation of the reservation. The payment parameters for the trip item may comprise a percentage of a total amount due and a due date comprising a number of days before the start date of the trip. In one example, a parameter may be that full payment is due thirty days before the start date of an item (e.g., a check-in date for an accommodation, a start date of a tour or other activity, etc.). In another example, one payment parameter may be that 50% of the total payment is due thirty days before the start date of the trip item, another parameter is that 66% of total payment is due seven days before the start date for the trip item, and 100% is due one day before the start date for a trip item. The manager of a trip item may set any cancellation policy and one or more payment parameters desired by the manager of the trip item. In another example a system associated with a trip item may set the cancellation policy and one or more payment parameters.

In operation 306, the server computing system calculates, for each of a plurality of predetermined number of installment payments, a payment period for each payment parameter set for the trip item based on a time period before payment is due to meet each payment parameter and the predetermined number of installments for each of the plurality of predetermined number of installment payments. The predetermined number of installment payments may comprise at least a minimum and a maximum number of installment payments. For example, a minimum number of installment payment may be 2 and a maximum number of installment payments may be 4.

The number of installments (e.g., a minimum number of installments or a maximum number of installments) may be a default number used by the server computing system (e.g., 2, 3, 4, 5, etc.), may be determined based on a client profile, may be based on parameters set by a user, and so forth. For example, the server computing system may set a default number of installments for all installment plans. In another example, the server computing system may set a default number of installment plans based on the country in which the user resides. For example, some countries may be more predisposed to doing installment payment. For example, some countries may have lower average wages in respect to the amount of the trip item and so a larger number of installment payments for lower amounts may make more sense for certain countries. In other countries, installment payments may not be as standard and so fewer payments for larger amounts may make sense. A number of installments may be set for each country.

A default number of installments may also be set based on the time of year (e.g., particular holidays, high travel season, etc.), how far in advance the reservation is made (e.g., more installments for start dates farther out, fewer installments for sooner start dates), the total amount of the reservation (e.g., using certain threshold amounts for how many installments there should be at each range), and so forth.

In another example, the server computing system may analyze the client profile for a user to determine the number of installments. The server computing system may determine the country in which the user resides, payment history for previous trip items, booking session data, trustworthiness of the user, and so forth. For example, the server computing system may verify (or have previously verified) the user by, for example, confirming the user's established online identity (e.g., through client and manager reviews in the server computing system, via other social media reviews or profiles, etc.), confirming the user's offline identity by confirming historical personal information or by scanning the user's identification (e.g., government issued identification), matching the user's online and offline names, and so forth. A user who has been verified and thus, deemed trustworthy, may be provided more favorable number of installments or amount of installments or timing for installments. For example, if a user is deemed trustworthy, he may be provided with an installment plan that allows him to pay less up front and more closer to the start date of the trip item.

In one example of user verification, a user (e.g., Bob) would like to make a reservation for a trip item. Bob has used the online marketplace over ten times before to make reservations for various trip items and has had no previous payment issues. When electing to reserve the trip item, the online marketplace can provide Bob with an installment plan that requires 10% paid at the time of booking and 90% eight days before the trip. In contrast, if another user Billy, who has never used the online marketplace before tries to make that same booking, the platform may require that Billy pay 50% N at the time of booking and 50% eight days before the trip. In this way the platform can alter the proportions of upfront payment required by the user based on the user's trustworthiness on the platform and the user's likelihood of cancelling before completing full payment.

In another example, if Bradley, booked a trip previously where he was offered an installment plan, but never completed the payments and the trip was canceled because of the incomplete payment, the platform can adjust the installment plan it offers to Bradley in the future. So next time Bradley books, he might be required to pay 65% at the timing of booking, or be required to pay 50% at the time of booking and the next 25% 30 days later, rather than waiting till only eight days before the trip, to charge the remainder of the payment.

In yet another example, the server computing system may provide an interface to the user to allow the user to select the number of installments that the user would like to have in the installment plan. For example, the user may enter a specific number, interact with a control in the interface such as a “slider” that adjusts the payments depending on the number of the installments indicated by the slider, and so forth.

Using the example provided above, where the cancellation policy for the trip item includes one payment parameter of 50% of the total payment due thirty days before the start date of the trip item, another parameter of 66% of total payment due seven days before the start date for the trip item, and another parameter of 100% due one day before the start date for the trip item, and where the start date for the trip item is ninety days out, the server computing system may match the installment plan to the payment parameters in the cancellation policy. For example, the server computing system may charge the user 25% at the time of booking the trip item, 25% thirty-one days before the start date of the trip item, 33% eight days before the start of the trip, and 34% one day before the state date of the trip item.

In another example, instead of offering an installment plan that matches the cancellation policy exactly, the server computing system may present an option of equal installments (e.g., three equal installments) spread out over the time period between booking the reservation for the trip item and the start date for the trip item, such that no credit risk is taken, but with a simplified and equalized repayment plan. For example, the installment plan may be ⅓ at the time of booking the trip item, ⅓ forty-six days before the start date of the trip item, and ⅓ two days before the start date of the trip item.

An example algorithm which may be employed by the server computing system for equalized payments over various installment periods that is optimized for both the user and the platform (e.g., not incurring any credit risk based on the cancellation policies) is describe as follows. This is one example of how the server computing system may calculate, for each of a predetermined number of installment payments, a payment period for each payment parameter set for the trip item based on a time period before payment is due to meet each payment parameter and the predetermined number of installments.

A cancellation policy (e.g., a payment schedule) is defined as a set of n criteria C₁ . . . Cₙ, where:

Cᵢ=Guest must have paid proportion pᵢ(where 0<pᵢ≤1) of the total amount dᵢ days before occupancy will begin. The goal of the algorithm is to determine the optimal equal payment and equal time period installments for the guest that match the following conditions:
The first payment installment begins a fixed number Dₘₐₓ days before occupancy begins (e.g., the day a user is viewing the listing for the trip item or makes the booking for the trip item).
Payment installments are equal in monetary amount.
The number of days between any pair of consecutive payment installments is equal.
All payment parameters (e.g., cancellation/payment criteria defined by the host) are satisfied.
Of solutions satisfying all conditions above, the optimal solution is the one where the user's final payment installment is on the latest date (e.g., the fewest number of days before trip item start date) which means that the user has paid the total amount required in the longest amount of time that satisfies all the previous conditions.

The algorithm the platform uses to calculate the installment plan can then be defined as such:
Let m be the number of payment installments the user will make
Let Mₘᵢₙ be the minimum number of payment installments the platform is defined to allow, or if no such minimum is defined set Mₘᵢₙ=2.
Let Mₘₐₓ be the maximum number of payment installments the system is defined to allow, or if no such maximum is defined set Mₘₐₓ=Dₘₐₓ
For m=Mₘᵢₙ, Mₘᵢₙ+1, . . . , Mₘₐₓ:
   Set Gₘₐₓ=floor (Dₘₐₓ/(m− 1)) where floor means round down to the nearest integer
   Let i be the number of the host criterion (e.g., cancellation policy payment parameters set for the trip item) being optimized for
   For i=1, 2, . . . , n:
      Let g be the number of days between consecutive payment installments
      Let gᵢ be the optimal number of days between consecutive payment installments to satisfy the i^{th} iteration of the loop
      For g=Gₘₐₓ, Gₘₐₓ− 1, . . . , 1:
         Check whether m payment installments, starting Dₘₐₓ days before start date of trip item will begin, each of proportion 1/m of the total payment amount, with g days between consecutive payments, satisfies criterion Cᵢ, e.g., whether (floor((Dₘₐₓ−dᵢ)/g)+1)/m≥pᵢ
         If criterion Cᵢ is satisfied, set gᵢ to g, and stop iterating over values of g for the current loop
   Let fₘ be the optimal number of days between consecutive payment installments for this number of payment installments m
   Set fₘ=min(g₁, g₂, . . . , gₙ) (since each gᵢ represents the maximum number of days between consecutive payment installments that will actually satisfy criterion Cᵢ, so any value larger than fₘ will be larger than gⱼ for some j which would violate criterion Cⱼ).
   Let Dₘ be the optimal (e.g., minimum) number of days between the users' final payment installment and the trip item start date for this number of payment installments m
   Set Dₘ=Dₘₐₓ− (fₘ*(m− 1))
Let Dₒₚₜ be the optimal (e.g., minimum) number of days between the user's final payment installment and the trip item start date
Set Dₒₚₜ=min(D_{M[min]}, D_{M[min]+1}, . . . , D_{M[max]})
Let Mₒₚₜ be the optimal number of payments for the user to make
Set Mₒₚₜ to the value m where Dₘ=Dₒₚₜ (if there are multiple such values, use any tiebreakers defined by the system, or if none are defined, pick the smallest such value of m)
We have now determined the optimal payment installment plan that satisfies all trip item criteria (e.g., payment parameters set for a trip item): the user will make Mₒₚₜ payments every f_{M[opt]} days starting Dₘₐₓ days before start date of trip item (each installment being in the amount of 1/Mₒₚₜ of the total payment amount)
Note: In the event that no g can be found that satisfies all Cᵢ for any value of m, then an installment plan with equal amounts and equal time period payments is not possible, and the user may pay 100% of the amount at the time of the booking.

Using a simple example, where the cancellation policy for the trip item includes one payment parameter of 50% of the total payment due thirty days before the start date of the trip item, another parameter of 67% of total payment due seven days before the start date for the trip item, and another parameter of 100% due one day before the start date for the trip item, and where the start date for the trip item is ninety days out, and the maximum number of installments allowed by the platform is set to three, then:

```
C₁: At d₁ = 30 days before start date of trip item, user must have
repaid p₁ = 0.5
C₂: At d₂ = 7 days before start date of trip item, user must have
repaid p₂ = 0.67
C₃: At d₃ = 1 days before start date of trip item, guest must have
repaid p₃ = 1.0
Dₘₐₓ = 90 days
Mₘᵢₙ = 2
Mₘₐₓ = 3
  For m = 2, 3:
    @ m=2 (e.g., 2 × 50% payment installments)
    Gₘₐₓ = floor(90/(2 − 1)) = 90
    For i = 1, 2, 3: (e.g., payment parameters of cancellation policy)
      @i=1 (e.g., 50% at 30 days)
      For g = 90, 89, ... 1:
        @ g=90 days
        Check for C₁: Is (floor( 90 − 30) / 90 + 1) / 2 = 0.5 ≥
        p₁ = 0.5?
        Yes, so stop iterating g and set g₁ = 90
      @i=2 (e.g., 67% at 7 days)
      For g = 90, 89, ... 1:
        @ g=90 days
        Check for C₂: Is (floor((90 − 7) / 90) + 1) / 2 = 0.5 ≥
        p₂ = 0.67?
        No, so iterate g.
        ... (repeat for @g=89 to @g=84, which will not pass
        the C₂ check)
        @ g=83 days
        Check for C₂: Is (floor((90 − 7) / 83) + 1) / 2 = 1 ≥ p₂
        = 0.67?
        Yes, so stop iterating g and set g₂ = 83
      @i=3 (e.g., 100% at 1 day)
      For g = 90, 89, ... 1:
        @ g=90 days
        Check for C₃: Is (floor((90 − 1) / 90) + 1) / 2 = 0.5 ≥
        p₃ = 1.0?
        No, so iterate g.
        @ g=89 days
        Check for C₃: Is (floor((90 − 1) / 89) + 1) / 2 = 1 ≥ p₃
        =1.0?
        Yes, so stop iterating g and set g₃ = 89
    f₂ = min(g₁, g₂, g₃) = min(90, 83, 89) = 83
    D₂ = 90 − (83 * (2 − 1)) = 7
    @ m=3 (e.g., 3 × 33.33% payment installments)
    Gₘₐₓ = floor(90/ (3 − 1)) = 45
    For i = 1, 2, 3:
      @i=1
      For g = 45, 44, 43... 1:
        @ g=45 days
        Check for C₁: Is (floor((90 − 30) / 45) + 1) / 3 = 0.67 ≥
        p₁ = 0.5?
        Yes, so stop iterating g and set g₁ = 45
      @i=2
      For g = 45, 44, 43... 1:
        @ g=45 days
        Check for C₂: Is (floor((90 − 7) / 45) + 1) / 3 = 067 ≥
        p₂ = 0.67?
        Yes, so stop iterating g and set g₂ = 45
      @i=3
      For g = 45, 44, 43... 1:
        @ g=45 days
        Check for C₃: Is (floor ((90 − 1) / 45) + 1) / 3 = 0.67 ≥
        p₃ = 1.0?
        No, so iterate g.
        @ g=44 days
        Check for C₃: Is (floor((90 − 1) / 44) + 1) / 3 = 1.0 ≥
        p₃ = 1.0?
        Yes, so stop iterating g and set g₃ = 44
    f₃ = min(g₁, g₂, g₃) = min(45, 45, 44) = 44
    D₃ = 90 − (44 * (3 − 1)) = 2
  Dₒₚₜ = min(D₂, D₃) = min(7, 2) = 2
  Mₒₚₜ = 3 since D₃ = Dₒₚₜ when m = 3
```

Thus, in this example, the optimal plan is for the user to make Mopt=3 installment payments, every f3=44 days starting Dmax=90 days before start date of trip item, with each installment being 1/Mopt=0.33 of the total amount. This would create an installment schedule of:

User pays 0.33 of the amount 90 days before occupancy,

User pays 0.33 of the amount 46 days before occupancy, and

User pays 0.33 of the amount 2 days before occupancy.

Accordingly, the above example describes calculating a payment period for each payment parameter set for the trip item based on a time period before payment is due to meet each payment parameter and the predetermined number of installments comprising calculating an optimal number of days between a final installment payment and the start date of the trip item, that meet the payment parameters set for the trip item. Calculating an optimal number of days between a final installment payment and the start date of the trip item, that meet the payment parameters set for the trip item may comprise generating a number of days to satisfy each payment parameter set for the trip item, determining, a minimum number of days of the generated number of days, and determining the optimal number of days between the final installment payment and the start date of the trip item for the number of installment payments based on a payment period for the trip item, the minimum number of days of the generated number of days, and the number of installment payments. In this example, the optimal number of days is a minimum number of days between a final installment payment and the start date of the trip item, that meet the payment parameters set for the trip item.

In operation 308, the server computing system selects a number of predetermined installment payments of the plurality of predetermined number of installment payments that comprises an optimal payment period between a final installment payment and the start date of the trip item. For example, the server computing system would select 3 installment payments in the example described above, as this number of installment payments comprises the optimal payment period (e.g., 2 days) between a final installment payment and the start date of the trip item.

In operation 310, the server computing system generates an installment plan based on the selected number of predetermined installment payments, the installment plan comprising a date and amount for each installment payment. Using the example described above, the server computing system may generate an installment plan where the user pays 0.33 of the amount 90 days before occupancy, 0.33 of the amount 46 days before occupancy, and 0.33 of the amount 2 days before occupancy. The server computing system determines the total amount of the reservation for the trip item (e.g., based on the number of days in the date range of the trip item and the amount per day (or per trip item) of the trip item). The server computing system may then divide the total amount for the reservation of the trip item into the installment payments and cause the installment plan to be presented via the computing device. For example, the installment plan information 415 may be presented to the user in a user interface 400 on the computing device when booking the reservation for the trip item, as shown in FIG. 4.

In one example, the dates of the installment plan may be adjusted to be more intuitive to the user. For example, the dates could be adjusted to fall at the beginning, middle, or end of the month. The server computing system would consider the parameters of the cancellation policy in adjusting the dates to be sure that the dates still conform to receiving payment within the parameters of the cancellation policy. In the example shown in FIG. 4, the dates for the second and third installments may be adjusted to May 15 and July 1, as an example.

In another example, installation plans may be calculated where the online marketplace does assume some specified amount of maximum credit risk, but the risk is further reduced by tailoring the plan to the cancellation policy of the manager of the trip item. For example, a specified amount of maximum credit risk may be 10% of the installment plan. For cancellation policy A, the online marketplace (e.g., via the server computing system) can offer an installment plan that allows for 45% being collected at the time of booking, 45% at day 31 prior to the start date of the trip item, and 10% 30 days after the start date of the trip item. In this manner the installment plan offered takes into account both the online marketplace's threshold for risk exposure, and the cancellation policy, to offer a plan that offers the user terms that limit the risk exposure for the online marketplace.

The installment plan where the online marketplace does assume some risk, may be calculated similar to the examples above with an additional payment, or payments, for the payment amount specified by the online platform on the date or dates specified by the online platform. Using the example above, if the online marketplace assumes 10% risk, then the installment plan would be calculated for the 90% of the payment as described above, and then the last payment of 10% of the total amount would be set at the date specified by the online marketplace (e.g., on the start date of the trip item, 10 days after the start date of the trip item, 30 days after the start date of the trip item, etc.). In another example, the 10% can be split into separate payments on separate payments dates (e.g., two payments, three payments, etc.).

Example embodiments allow for dynamic installment plans which are optimized to both provide the user with optimal payment terms and at the same time not create credit risk for the online marketplace.

Example embodiments allow for a method for displaying transaction data (e.g., including an installment plan) associated with a trip item in an electronic market place. For example, the server computing system (or other computing device) may cause a display of at least one visual indicator of the trip item in an item display region of a graphical user interface of a computing device, as shown in FIG. 4. For example, the server computing system may cause a visual indicator of the trip item such as a title 401 of the trip item, a brief description 403 of the trip item, a detailed description 409 of the trip item, pricing information 411 of the trip item, the listing host's information 413, or other visual indicator of the trip item (or a combination of visual indicators as shown in FIG. 4). The trip item may be one of a plurality of trip items offered in the electronic market place and each trip item of the plurality of trip items may have at least one visual indicator showing a visual representation of the trip item.

The server computing system may further cause a display of at least one visual indicator of a trip item in an item display region of a graphical user interface of a computing device. The visual indicator may be date range indicators in a date range region of the graphical user interface. The trip item may be one of a plurality of trip items offered in the electronic market place where each trip item of the plurality of trip items may have at least one visual indicator showing a visual representation of the trip item. An example display of visual indicators comprising date range indicators are the check-in date range indicator 417 and the check-out date range indicator 417.

The server computing system may receive, from a computing device, a date range selection for a reservation of the trip item. As explained above, a user associated with the computing device may select a date range using the date range indicators to indicate specific dates for which the user would like to reserve the trip item.

The server computing system may access a database including cancellation policy data associated with the trip item, and determine a plurality of payment parameters for the trip item. For each of the plurality of predetermined number of installment payments, the server computing system calculates a payment period for each payment parameter set for the trip item based on a time period before payment is due to meet each payment parameter and the predetermined number of installments. The server computing system may select a number of predetermined installment payments of the plurality of predetermined number of installment payments that comprises an optimal payment period between a final installment payment and the start date of the trip item and generate an installment plan based on the selected number of predetermined installment payments, the installment plan comprising a date and amount for each installment payment. The server computing system may cause a display of the transaction data in a transaction data region of the graphical user interface, such as the installment plan 415 shown in FIG. 4.

In various example embodiments a server computing system is described as performing operations. In the various example embodiments another computing device, such as a client device 110, may perform the operations or a combination of a server computing system and a client device may perform the operations.

The following examples describe various embodiments of methods, machine-readable media, and systems (e.g., machines, devices, or other apparatus) discussed herein.

### Example 1

A method, comprising:

receiving, by a server computing system from a computing device associated with a user, a date range for a reservation for a trip item;

analyzing, by the server computing system, a cancellation policy for the trip item to determine payment parameters set for the trip item;

for each of a plurality of predetermined number of installment payments, calculating, by the server computing system, a payment period for each payment parameter set for the trip item based on a time period before payment is due to meet each payment parameter and the predetermined number of installments;

selecting, by the server computing system, a number of predetermined installment payments of the plurality of predetermined number of installment payments that comprises an optimal payment period between a final installment payment and the start date of the trip item;

generating, by the server computing system, an installment plan based on the selected number of predetermined installment payments, the installment plan comprising a date and amount for each installment payment; and

causing, by the server computing system, the installment plan to be presented via the computing device.

### Example 2

A method according to example 1, wherein the payment parameters for the trip item each comprise a percentage of a total amount due and a due date comprising a number of days before the start date of the trip item.

### Example 3

A method according to any of the previous examples, wherein the predetermined number of installment payments comprises at least a minimum number of installment payments and a maximum number of installment payments.

### Example 4

A method according to any of the previous examples, wherein the maximum number of installment payments is determined by one or more of a group comprising: a trustworthiness of the user, the user payment history, and a country of residence for the users.

### Example 5

A method according to any of the previous examples, wherein calculating a payment period for each payment parameter set for the trip item based on a time period before payment is due to meet each payment parameter and the predetermined number of installments comprises

calculating an optimal number of days between a final installment payment and the start date of the trip item, that meet the payment parameters set for the trip item.

### Example 6

A method according to any of the previous examples, wherein calculating an optimal number of days between a final installment payment and the start date of the trip item, that meet the payment parameters set for the trip item comprises:

generating a number of days to satisfy each payment parameter set for the trip item;

determining, a minimum number of days of the generated number of days;

determining the optimal number of days between the final installment payment and the start date of the trip item for the number of installment payments based on a payment period for the trip item, the minimum number of days of the generated number of days, and the number of installment payments.

### Example 7

A method according to any of the previous examples, wherein the optimal number of days is a minimum number of days between a final installment payment and the start date of the trip item, that meet the payment parameters set for the trip item.

### Example 8

A method according to any of the previous examples, wherein the server computing system is associated with an online marketplace comprising a plurality of trip items and a plurality of managers associated with one or more trip items.

### Example 9

A method according to any of the previous examples, wherein the trip item comprises an accommodation, a tour, a car rental, a flight, transportation, or an activity related to a trip.

### Example 10

A method according to any of the previous examples, wherein the installment plan is presented to the user in a user interface on the computing device when booking the reservation for the trip item.

### Example 11

A server computer comprising:

at least one processor; and

a computer-readable medium coupled with the at least one processor, the computer-readable medium comprising instructions stored thereon that are executable by the at least one processor to cause the server computer to perform operations comprising:

receiving, from a computing device associated with a user, a date range for a reservation for a trip item;

analyzing a cancellation policy for the trip item to determine payment parameters set for the trip item;

for each of a plurality of predetermined number of installment payments, calculating a payment period for each payment parameter set for the trip item based on a time period before payment is due to meet each payment parameter and the predetermined number of installments;

selecting a number of predetermined installment payments of the plurality of predetermined number of installment payments that comprises an optimal payment period between a final installment payment and the start date of the trip item;

generating an installment plan based on the selected number of predetermined installment payments, the installment plan comprising a date and amount for each installment payment; and

causing the installment plan to be presented via the computing device.

### Example 12

A server computer according to any of the previous examples, wherein the payment parameters for the trip item each comprise a percentage of a total amount due and a due date comprising a number of days before the start date of the trip item.

### Example 13

A server computer according to any of the previous examples, wherein the predetermined number of installment payments comprises at least a minimum number of installment payments and a maximum number of installment payments.

### Example 14

A server computer according to any of the previous examples, wherein the maximum number of installment payments is determined by one or more of a group comprising: a trustworthiness of the user, the user payment history, and a country of residence for the users.

### Example 15

A server computer according to any of the previous examples, wherein calculating a payment period for each payment parameter set for the trip item based on a time period before payment is due to meet each payment parameter and the predetermined number of installments comprises calculating an optimal number of days between a final installment payment and the start date of the trip item, that meet the payment parameters set for the trip item.

### Example 16

A server computer according to any of the previous examples, wherein calculating an optimal number of days between a final installment payment and the start date of the trip item, that meet the payment parameters set for the trip item comprises:

generating a number of days to satisfy each payment parameter set for the trip item;

determining, a minimum number of days of the generated number of days;

determining the optimal number of days between the final installment payment and the start date of the trip item for the number of installment payments based on a payment period for the trip item, the minimum number of days of the generated number of days, and the number of installment payments.

### Example 17

A server computer according to any of the previous examples, wherein the optimal number of days is a minimum number of days between a final installment payment and the start date of the trip item, that meet the payment parameters set for the trip item.

### Example 18

A server computer according to any of the previous examples, wherein the server computing system is associated with an online marketplace comprising a plurality of trip items and a plurality of managers associated with one or more trip items.

### Example 19

A server computer according to any of the previous examples, wherein the trip item comprises an accommodation, a tour, a car rental, a flight, transportation, or an activity related to a trip.

### Example 20

A method for displaying transaction data associated with a trip item in an electronic market place, the method comprising;

causing display of at least one visual indicator of the trip item in an item display region of a graphical user interface of a computing device, the trip item being one of a plurality of trip items offered in the electronic market place and each trip item of the plurality of trip items having at least one visual indicator showing a visual representation of the trip item;

causing display of date range indicators in a date range region of the graphical user interface;

receiving, from the computing device, a date range selection for a reservation of the trip item;

accessing, using at least one hardware processor, a database including cancellation policy data associated with the trip item;

determining, using the at least one hardware processor, a plurality payment parameters for the trip item;

for each of a plurality of predetermined number of installment payments, calculating, using the at least one hardware processor, a payment period for each payment parameter set for the trip item based on a time period before payment is due to meet each payment parameter and the predetermined number of installments;

selecting, using the at least one hardware processor, a number of predetermined installment payments of the plurality of predetermined number of installment payments that comprises an optimal payment period between a final installment payment and the start date of the trip item;

generating an installment plan based on the selected number of predetermined installment payments, the installment plan comprising a date and amount for each installment payment; and

causing display of the transaction data in a transaction data region of the graphical user interface.

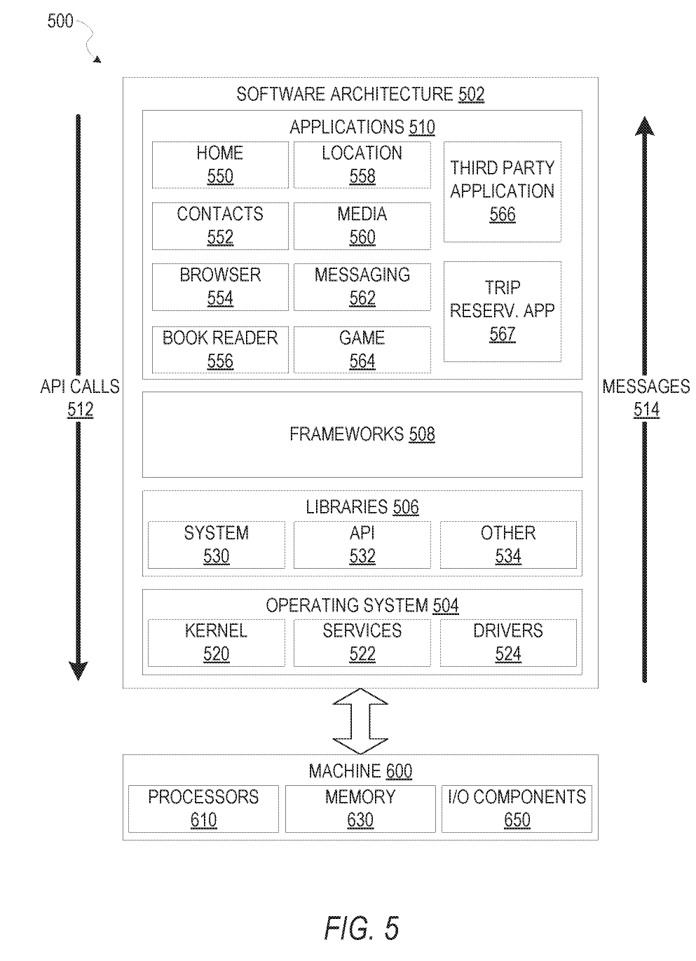

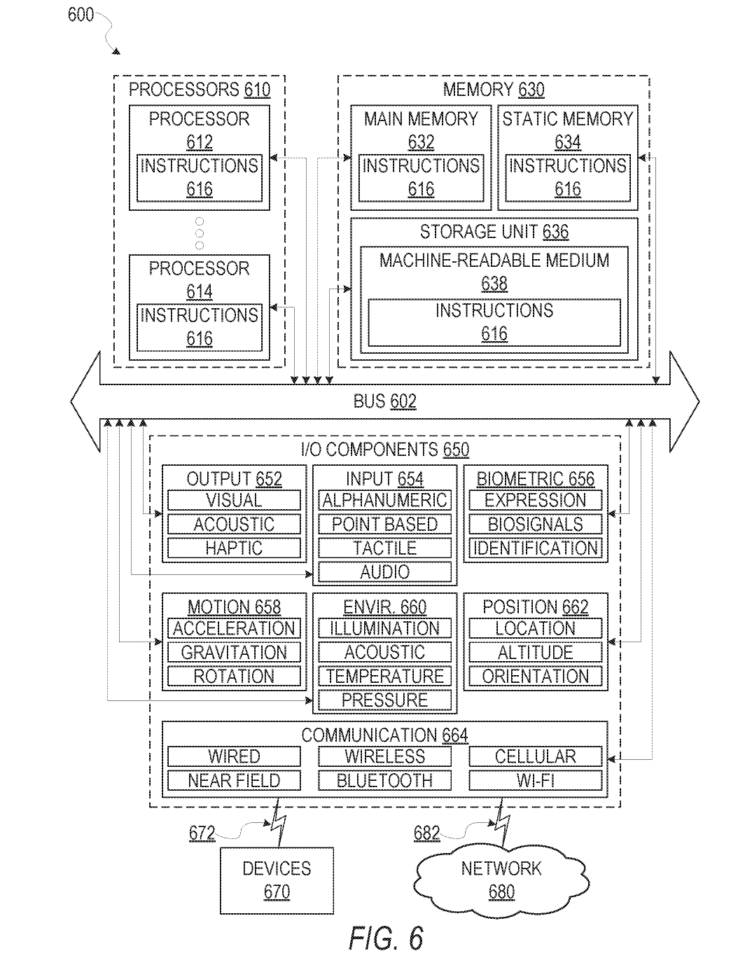

FIG. 5 is a block diagram 500 illustrating software architecture 502, which can be installed on any one or more of the devices described above. For example, in various embodiments, client devices 110 and server systems 130, 102, 120, 122, and 124 may be implemented using some or all of the elements of software architecture 502. FIG. 5 is merely a non-limiting example of a software architecture, and it will be appreciated that many other architectures can be implemented to facilitate the functionality described herein. In various embodiments, the software architecture 502 is implemented by hardware such as machine 600 of FIG. 6 that includes processors 610, memory 630, and I/O components 650. In this example, the software architecture 502 can be conceptualized as a stack of layers where each layer may provide a particular functionality. For example, the software architecture 502 includes layers such as an operating system 504, libraries 506, frameworks 508, and applications 510. Operationally, the applications 510 invoke application programming interface (API) calls 512 through the software stack and receive messages 514 in response to the API calls 512, consistent with some embodiments.

In various implementations, the operating system 504 manages hardware resources and provides common services. The operating system 504 includes, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionality. The services 522 can provide other common services for the other software layers. The drivers 524 are responsible for controlling or interfacing with the underlying hardware, according to some embodiments. For instance, the drivers 524 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 506 provide a low-level common infrastructure utilized by the applications 510. The libraries 506 can include system libraries 530 (e.g., C standard library) that can provide functions such as memory allocation functions, string manipulation functions, mathematic functions, and the like. In addition, the libraries 506 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and in three dimensions (3D) graphic content on a display), database libraries (e.g., SQLite to provide various relational database functions), web libraries (e.g., WebKit to provide web browsing functionality), and the like. The libraries 506 can also include a wide variety of other libraries 534 to provide many other APIs to the applications 510.

The frameworks 508 provide a high-level common infrastructure that can be utilized by the applications 510, according to some embodiments. For example, the frameworks 508 provide various graphic user interface (GUI) functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 include a home application 550, a contacts application 552, a browser application 554, a book reader application 556, a location application 558, a media application 560, a messaging application 562, a game application 564, and a broad assortment of other applications such as a third party applications 566. According to some embodiments, the applications 510 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third party application 566 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third party application 566 can invoke the API calls 512 provided by the operating system 504 to facilitate functionality described herein.

Some embodiments may particularly include a trip reservation application 567, which may be any application that requests data or other tasks to be performed by systems and servers described herein, such as server system 102, third party servers 130, and so forth. In certain embodiments, this may be a stand-alone application that operates to manage communications with a server system such as third party servers 130 or server system 102. In other embodiments, this functionality may be integrated with another application. The trip reservation application 567 may request and display various data related to an online marketplace and may provide the capability for a user 106 to input data related to the system via voice, a touch interface, a keyboard, or using a camera device of machine 600, communication with a server system via I/O components 650, and receipt and storage of object data in memory 630. Presentation of information and user inputs associated with the information may be managed by trip reservation application 567 using different frameworks 508, library 506 elements, or operating system 504 elements operating on a machine 600.

FIG. 6 is a block diagram illustrating components of a machine 600, according to some embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 616 (e.g., software, a program, an application 510, an applet, an app, or other executable code) for causing the machine 600 to perform any one or more of the methodologies discussed herein can be executed. In alternative embodiments, the machine 600 operates as a standalone device or can be coupled (e.g., networked) to other machines. In a networked deployment, the machine 600 may operate in the capacity of a server machine 130, 102, 120, 122, 124 and the like, or a client device 110 in a server-client network environment, or as a peer machine in a peer-to-peer (or distributed) network environment. The machine 600 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

In various embodiments, the machine 600 comprises processors 610, memory 630, and I/O components 650, which can be configured to communicate with each other via a bus 602. In an example embodiment, the processors 610 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 612 and a processor 614 that may execute the instructions 616. The term “processor” is intended to include multi-core processors 610 that may comprise two or more independent processors 612, 614 (also referred to as “cores”) that can execute instructions 616 contemporaneously. Although FIG. 6 shows multiple processors 610, the machine 600 may include a single processor 610 with a single core, a single processor 610 with multiple cores (e.g., a multi-core processor 610), multiple processors 612, 614 with a single core, multiple processors 612, 614 with multiple cores, or any combination thereof.

The memory 630 comprises a main memory 632, a static memory 634, and a storage unit 636 accessible to the processors 610 via the bus 602, according to some embodiments. The storage unit 636 can include a machine-readable medium 638 on which are stored the instructions 616 embodying any one or more of the methodologies or functions described herein. The instructions 616 can also reside, completely or at least partially, within the main memory 632, within the static memory 634, within at least one of the processors 610 (e.g., within the processor's cache memory), or any suitable combination thereof, during execution thereof by the machine 600. Accordingly, in various embodiments, the main memory 632, the static memory 634, and the processors 610 are considered machine-readable media 638.

As used herein, the term “memory” refers to a machine-readable medium 638 able to store data temporarily or permanently and may be taken to include, but not be limited to, random-access memory (RAM), read-only memory (ROM), buffer memory, flash memory, and cache memory. While the machine-readable medium 638 is shown, in an example embodiment, to be a single medium, the term “machine-readable medium” should be taken to include a single medium or multiple media (e.g., a centralized or distributed database, or associated caches and servers) able to store the instructions 616. The term “machine-readable medium” shall also be taken to include any medium, or combination of multiple media, that is capable of storing instructions (e.g., instructions 616) for execution by a machine (e.g., machine 600), such that the instructions 616, when executed by one or more processors of the machine 600 (e.g., processors 610), cause the machine 600 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 650 include a wide variety of components to receive input, provide output, produce output, transmit information, exchange information, capture measurements, and so on. In general, it will be appreciated that the I/O components 650 can include many other components that are not shown in FIG. 6. The I/O components 650 are grouped according to functionality merely for simplifying the following discussion, and the grouping is in no way limiting. In various example embodiments, the I/O components 650 include output components 652 and input components 654. The output components 652 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 654 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 650 include biometric components 656, motion components 658, environmental components 660, or position components 662, among a wide array of other components. For example, the biometric components 656 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 658 include acceleration sensor components (e.g., accelerometer), gravitation sensor components, rotation sensor components (e.g., gyroscope), and so forth. The environmental components 660 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 662 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 650 may include communication components 664 operable to couple the machine 600 to a network 680 or devices 670 via a coupling 682 and a coupling 672, respectively. For example, the communication components 664 include a network interface component or another suitable device to interface with the network 680. In further examples, communication components 664 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 670 may be another machine 600 or any of a wide variety of peripheral devices (e.g., a peripheral device coupled via a Universal Serial Bus (USB)).

Moreover, in some embodiments, the communication components 664 detect identifiers or include components operable to detect identifiers. For example, the communication components 664 include radio frequency identification (RFID) tag reader components, Near-field Communication (NFC) smart tag detection components, optical reader components (e.g., an optical sensor to detect a one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 664, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 680 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 682 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 616 are transmitted or received over the network 680 using a transmission medium via a network interface device (e.g., a network interface component included in the communication components 664) and utilizing any one of a number of well-known transfer protocols (e.g., Hypertext Transfer Protocol (HTTP)). Similarly, in other example embodiments, the instructions 616 are transmitted or received using a transmission medium via the coupling 672 (e.g., a peer-to-peer coupling) to the devices 670. The term “transmission medium” shall be taken to include any intangible medium that is capable of storing, encoding, or carrying the instructions 616 for execution by the machine 600, and includes digital or analog communications signals or other intangible media to facilitate communication of such software.

Furthermore, the machine-readable medium 638 is non-transitory (in other words, not having any transitory signals) in that it does not embody a propagating signal. However, labeling the machine-readable medium 638 “non-transitory” should not be construed to mean that the medium is incapable of movement; the medium 638 should be considered as being transportable from one physical location to another. Additionally, since the machine-readable medium 638 is tangible, the medium 638 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method, comprising:
receiving, by a server computing system from a computing device associated with a user, a date range for a reservation for a trip item;
analyzing, by the server computing system, a cancellation policy for the trip item to determine payment parameters set for the trip item;
for each of a plurality of predetermined number of installment payments, calculating, by the server computing system, a payment period for each payment parameter set for the trip item based on a time period before payment is due to meet each payment parameter and the predetermined number of installments;
selecting, by the server computing system, a number of predetermined installment payments of the plurality of predetermined number of installment payments that comprises an optimal payment period between a final installment payment and the start date of the trip item;
generating, by the server computing system, an installment plan based on the selected number of predetermined installment payments, the installment plan comprising a date and amount for each installment payment; and
causing, by the server computing system, the installment plan to be presented via the computing device.

2. The method of claim 1, wherein the payment parameters for the trip item each comprise a percentage of a total amount due and a due date comprising a number of days before the start date of the trip item.

3. The method of claim 1, wherein the predetermined number of installment payments comprises at least a minimum number of installment payments and a maximum number of installment payments.

4. The method of claim 3, wherein the maximum number of installment payments is determined by one or more of a group comprising: a trustworthiness of the user, the user payment history, and a country of residence for the users.

5. The method of claim 1, wherein calculating a payment period for each payment parameter set for the trip item based on a time period before payment is due to meet each payment parameter and the predetermined number of installments comprises calculating an optimal number of days between a final installment payment and the start date of the trip item, that meet the payment parameters set for the trip item.

6. The method of claim 5, wherein calculating an optimal number of days between a final installment payment and the start date of the trip item, that meet the payment parameters set for the trip item comprises:
generating a number of days to satisfy each payment parameter set for the trip item;
determining, a minimum number of days of the generated number of days;
determining the optimal number of days between the final installment payment and the start date of the trip item for the number of installment payments based on a payment period for the trip item, the minimum number of days of the generated number of days, and the number of installment payments.

7. The method of claim 1, wherein the optimal number of days is a minimum number of days between a final installment payment and the start date of the trip item, that meet the payment parameters set for the trip item.

8. The method of claim 1, wherein the server computing system is associated with an online marketplace comprising a plurality of trip items and a plurality of managers associated with one or more trip items.

9. The method of claim 1, wherein the trip item comprises an accommodation, a tour, a car rental, a flight, transportation, or an activity related to a trip.

10. The method of claim 1, wherein the installment plan is presented to the user in a user interface on the computing device when booking the reservation for the trip item.

11. A server computer comprising:
at least one processor; and
a computer-readable medium coupled with the at least one processor, the computer-readable medium comprising instructions stored thereon that are executable by the at least one processor to cause the server computer to perform operations comprising:
receiving, from a computing device associated with a user, a date range for a reservation for a trip item;
analyzing a cancellation policy for the trip item to determine payment parameters set for the trip item;
for each of a plurality of predetermined number of installment payments, calculating a payment period for each payment parameter set for the trip item based on a time period before payment is due to meet each payment parameter and the predetermined number of installments;
selecting a number of predetermined installment payments of the plurality of predetermined number of installment payments that comprises an optimal payment period between a final installment payment and the start date of the trip item;
generating an installment plan based on the selected number of predetermined installment payments, the installment plan comprising a date and amount for each installment payment; and
causing the installment plan to be presented via the computing device.

12. The server computer of claim 11, wherein the payment parameters for the trip item each comprise a percentage of a total amount due and a due date comprising a number of days before the start date of the trip item.

13. The server computer of claim 11, wherein the predetermined number of installment payments comprises at least a minimum number of installment payments and a maximum number of installment payments.

14. The server computer of claim 13, wherein the maximum number of installment payments is determined by one or more of a group comprising: a trustworthiness of the user, the user payment history, and a country of residence for the users.

15. The server computer of claim 11, wherein calculating a payment period for each payment parameter set for the trip item based on a time period before payment is due to meet each payment parameter and the predetermined number of installments comprises calculating an optimal number of days between a final installment payment and the start date of the trip item, that meet the payment parameters set for the trip item.

16. The server computer of claim 15, wherein calculating an optimal number of days between a final installment payment and the start date of the trip item, that meet the payment parameters set for the trip item comprises:
generating a number of days to satisfy each payment parameter set for the trip item;
determining, a minimum number of days of the generated number of days;
determining the optimal number of days between the final installment payment and the start date of the trip item for the number of installment payments based on a payment period for the trip item, the minimum number of days of the generated number of days, and the number of installment payments.

17. The server computer of claim 11, wherein the optimal number of days is a minimum number of days between a final installment payment and the start date of the trip item, that meet the payment parameters set for the trip item.

18. The server computer of claim 11, wherein the server computing system is associated with an online marketplace comprising a plurality of trip items and a plurality of managers associated with one or more trip items.

19. The server computer of claim 11, wherein the trip item comprises an accommodation, a tour, a car rental, a flight, transportation, or an activity related to a trip.

20. A method for displaying transaction data associated with a trip item in an electronic market place, the method comprising;
causing display of at least one visual indicator of the trip item in an item display region of a graphical user interface of a computing device, the trip item being one of a plurality of trip items offered in the electronic market place and each trip item of the plurality of trip items having at least one visual indicator showing a visual representation of the trip item;
causing display of date range indicators in a date range region of the graphical user interface;
receiving, from the computing device, a date range selection for a reservation of the trip item;
accessing, using at least one hardware processor, a database including cancellation policy data associated with the trip item;
determining, using the at least one hardware processor, a plurality payment parameters for the trip item;
for each of a plurality of predetermined number of installment payments, calculating, using the at least one hardware processor, a payment period for each payment parameter set for the trip item based on a time period before payment is due to meet each payment parameter and the predetermined number of installments;
selecting, using the at least one hardware processor, a number of predetermined installment payments of the plurality of predetermined number of installment payments that comprises an optimal payment period between a final installment payment and the start date of the trip item;
generating an installment plan based on the selected number of predetermined installment payments, the installment plan comprising a date and amount for each installment payment; and
causing display of the transaction data in a transaction data region of the graphical user interface.
